(19) United States
(12) Patent Application Publication
(10) Pub. No.: US 2013/0061671 A1
(43) Pub. Date: Mar. 14, 2013

(54) ACCELEROMETER

(71) Applicants: William E. McCracken, SR., Elmhurst, IL (US); William E. McCracken, JR., Elmhurst, IL (US)

(72) Inventors: William E. McCracken, SR., Elmhurst, IL (US); William E. McCracken, JR., Elmhurst, IL (US)

(21) Appl. No.: 13/542,438

(22) Filed: Jul. 5, 2012

Related U.S. Application Data
(60) Provisional application No. 61/504,590, filed on Jul. 5, 2011.

(51) Int. Cl. G01P 15/03; G01P 15/08; G01P 15/125

(52) U.S. Cl. 73/500; 73/514.09

(57) ABSTRACT

An accelerometer includes an enclosure and a flowable material disposed in the enclosure, A signal representing a shape of a surface of the flowable material in the enclosure is developed and a circuit is responsive to the signal for deriving an indication of acceleration.

### CROSS REFERENCE TO RELATED APPLICATION

The present application claims the benefit of U.S. Provisional patent application Ser. No. 61/504,590, filed Jul. 5, 2011, the contents of which are hereby incorporated herein by reference.

### DESCRIPTION OF PRIOR ART

Accelerometers have long been known and used for various applications. For example, accelerometers are used in various types of vehicles, for example, to obtain information concerning aircraft attitude and/or as an input to a flight data recorder to record aircraft movements, or as an input to a data storage unit of a automobile. Accelerometers are also used in handheld devices, such as smart phones and tablet devices.

One type of accelerometer utilizes a pivotally mounted proof mass that moves in response to changes in attitude of the device in which the accelerometer is used. The position of the proof mass is sensed, for example, by inductive or other sensors to obtain an indication of the attitude of the device.

### SUMMARY OF THE INVENTION

According to one aspect of the present invention, an accelerometer includes an enclosure and a flowable material disposed in the enclosure. Means are provided for developing a signal representing a shape of a surface of the flowable material in the enclosure as well as means responsive to the developing means for deriving an indication of acceleration from the signal.

According to a further aspect of the present invention, an accelerometer for detecting acceleration includes an enclosure, a flowable material disposed in the enclosure, and a plurality of sensors disposed about the enclosure and adapted to develop a plurality of signals representing a distribution of the flowable material in the enclosure. A circuit is responsive to the plurality of signals for developing a further signal representing a shape of a surface of the flowable material in the enclosure and for developing an indication of acceleration from the further signal.

According to yet another aspect of the present invention, a n accelerometer includes means defining a cavity, first and second freely-flowable materials disposed in the cavity, and means for detecting an interface between their freely-flowable materials to obtain an indication of acceleration.

### BRIEF DESCRIPTION OF THE DRAWINGS

FIG. 1 comprises an exploded isometric view of a portion of one aspect of an accelerometer;

FIG. 1A is a sectional view taken generally along the lines 1A-1A of the accelerometer of FIG. 1;

FIG. 2 is a simplified elevational view of the chamber of FIG. 1;

FIG. 3 is a view similar to FIG. 2 illustrating a nonlinearity in the interface between freely-flowable materials in the chamber of FIG. 1;

FIG. 4 is a combined fragmentary isometric view and block diagram of an aspect of an accelerometer used with a detection and display circuit;

FIG. 5 is an isometric view similar to FIG. 1 of a further aspect of an accelerometer;

FIGS. 6 and 7 are views similar to FIG. 2 illustrating an interface between two freely-flowable materials in the chamber of FIG. 5 under accelerating and decelerating conditions, respectively;

FIG. 8 is a view similar to FIG. 5 illustrating yet another aspect of an accelerometer;

FIG. 9 is a view similar to FIGS. 6 and 7 illustrating an interface between freely-flowable materials in the chamber of FIG. 8 under accelerating and decelerating conditions; and

FIGS. 10 and 11 are isometric views similar to FIG. 8 illustrating two further embodiments.

### DETAILED DESCRIPTION OF THE PREFERRED EMBODIMENTS

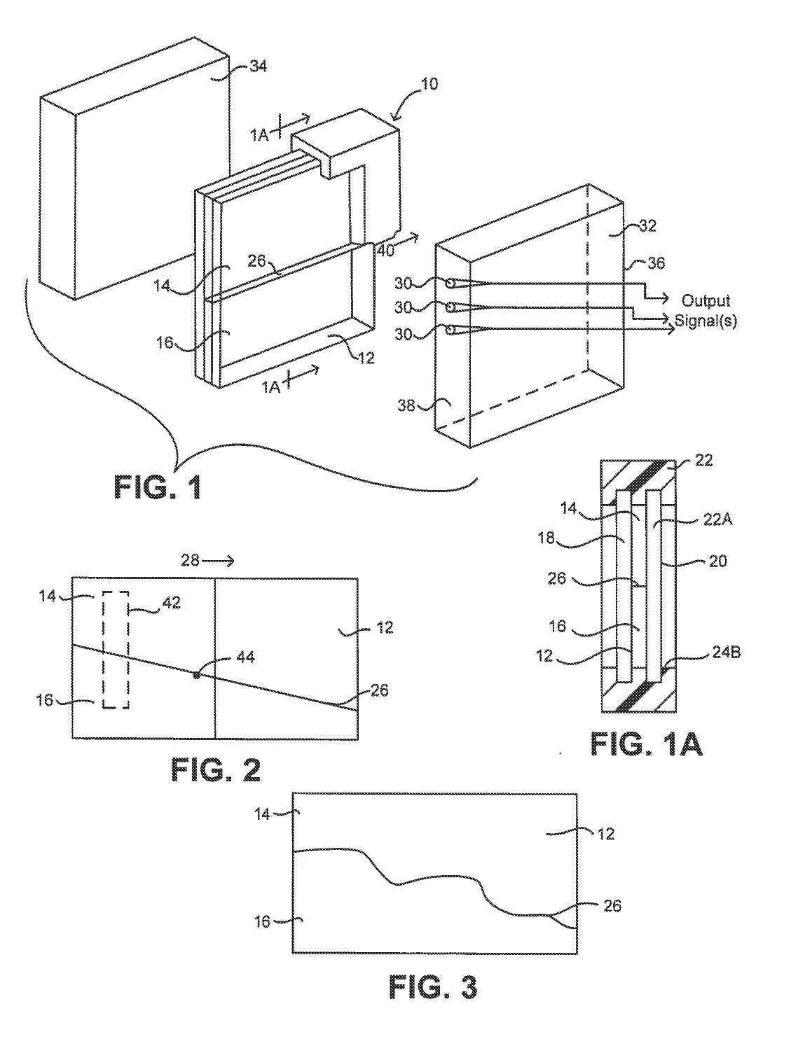

FIG. 1 illustrates a first embodiment of an accelerometer 10. The accelerometer 10 includes a chamber 12 that contains at least first and second freely-flowable materials 14, 16. Referring also to FIG. 1A, the chamber 12 includes first and second spaced planar members 18, 20 that are maintained in spaced relation by a frame 22. The frame 22 includes suitable means, represented by tabs 24A, 24B, that maintain the spacing between the planar members 18, 20. The frame 22 may be secured by any suitable means to the planar members 18, 20, such as by silicone adhesive caulk, or the like, to prevent leakage of the freely-flowable materials from the chamber 12.

An interface 26 between the freely-flowable materials 14, 16 is formed as a result of the freely-flowable materials being incapable of mixing, at least quickly. To that end, the materials 14, 16 may be two gases, a liquid and a gas, two liquids, a gas and a flowable solid, two flowable solids, etc. As noted in greater detail hereinafter, the choice of materials 14, 16 depends in large part upon the free flowability thereof, as well as the type of sensing that is to be used. For example, if an optical sensing scheme is to be employed, the first and second materials not only must be capable of free flowability, but must also have a least a minimum degree of difference in the optical characteristics thereof. For example, relatively immiscible liquids, such as mineral oil and water, could be used, where one or the other of the water and mineral oil may be dyed so that the interface between the materials 14, 16 can be easily detected by optical means. Thus, for example, the water may be dyed blue and the mineral oil may be undyed or may be dyed red (or another color) to obtain a distinct visual contrast between the two materials.

Alternatively, one might consider using a capacitance sensing device that relies upon at least two capacitive plates, one positioned on either side of the chamber 12 just above the resting level of the interface 26 (i.e., the level of the interface 26 when the accelerometer is not experiencing forces other than gravity and is disposed in a level orientation as seen in FIG. 2). In this embodiment, a dielectric material and non-dielectric material may be selected as the materials 14, 16, respectively. Alternatively the material 14 may be a non-dielectric material and the material 16 may be a dielectric material. Again, the materials should be free-flowing and should be relatively incapable of mixing in the short-term, for example, as a result of agitation.

A resistive sensing scheme could alternatively be used, in which case the planar members may comprise first and second electrodes positioned just above the level of the interface 26 when the accelerometer is not experiencing forces other than gravity and is disposed in a level orientation. The choice of material 16 could, for example, be an electrically conductive material whereas the material 14 could be nonconductive.

Other sensing schemes could be devised, in which case the choice of materials 14, 16 would be dependent upon such sensing scheme. Any differentiable characteristic in the free-flowing materials could be used and sensed to obtain an indication of acceleration. For example, one might use and sense an interface between materials at different temperatures, pressures, densities, viscosities, granularity (in the form of powders for example), or materials having different magnetic or inductive properties, etc.

As a further example, in the embodiment of FIGS. 1 and 1A, the material 14 may comprise ordinary air and the material 16 may comprise water. Regardless of the choice of the materials the interface 26 between the materials 14, 16 ideally may assume the shape as shown in FIG. 2 when the accelerometer is experiencing positive acceleration in the direction of an arrow 28. However, in practice, it is likely that standing waves or other disturbances may distort the interface 26 as seen in FIG. 3. Provided that no appreciable mixing of the materials 14, 16 occurs during changes in acceleration, the effect of such distortions can be minimized or eliminated entirely by appropriate signal processing techniques. For example, referring again to FIG. 1, one may use an optical device, such as an optical transistor, a charge coupled device (CCD), or the like 30 to sense a point or area optically and develop a representation in the form of a sensor output signal. The optical device 30 may be carried in a cover 32 that together with a further cover 34 and, possibly, the frame 22, serve with or without other components as a housing for the device 10. The optical device 30 may be positioned just above the level of the interface 26 when the accelerometer 10 is at rest. The optical device 30 is also positioned away from the front-to-back mid-plane of the device 10 i.e., away from the mid-line 44 (FIG. 2) between a front wall 36 and a rear wall 38 of the device 10. In the illustrated embodiment, the optical device 30 is positioned closer to the rear wall 38 than to the front wall 36 so as to detect when the rear portion of the interface 26 rises above the rest position seen in FIG. 1 (this condition is seen ideally in FIG. 2). This condition occurs when the device 10 accelerates in the direction of the arrow 40 (which is the same direction as the arrow 28 of FIG. 2). The occurrence of the interface 26 passing the optical device 30 may be sensed to develop an output signal indicative of acceleration exceeding a predetermined limit. By supplying multiple optical devices 30 upwardly in the cover of 32, one could detect multiple discrete acceleration points, if desired.

Alternatively, one could position a two-dimensional optical device, such as a camera having a field of view 42, for example, as seen in FIG. 2, and utilize appropriate detection circuitry to permit sensing of the interface 26 at a point removed from the mid-line 44. In this case, provided that the field of view 42 extends below the rest position of the interface 26, acceleration direction and magnitude can be measured.

In either optical embodiment described above, the output signals from the sensors 30 or the camera having the field of view 42 may be provided to appropriate detection circuitry to obtain an appropriate output signal.

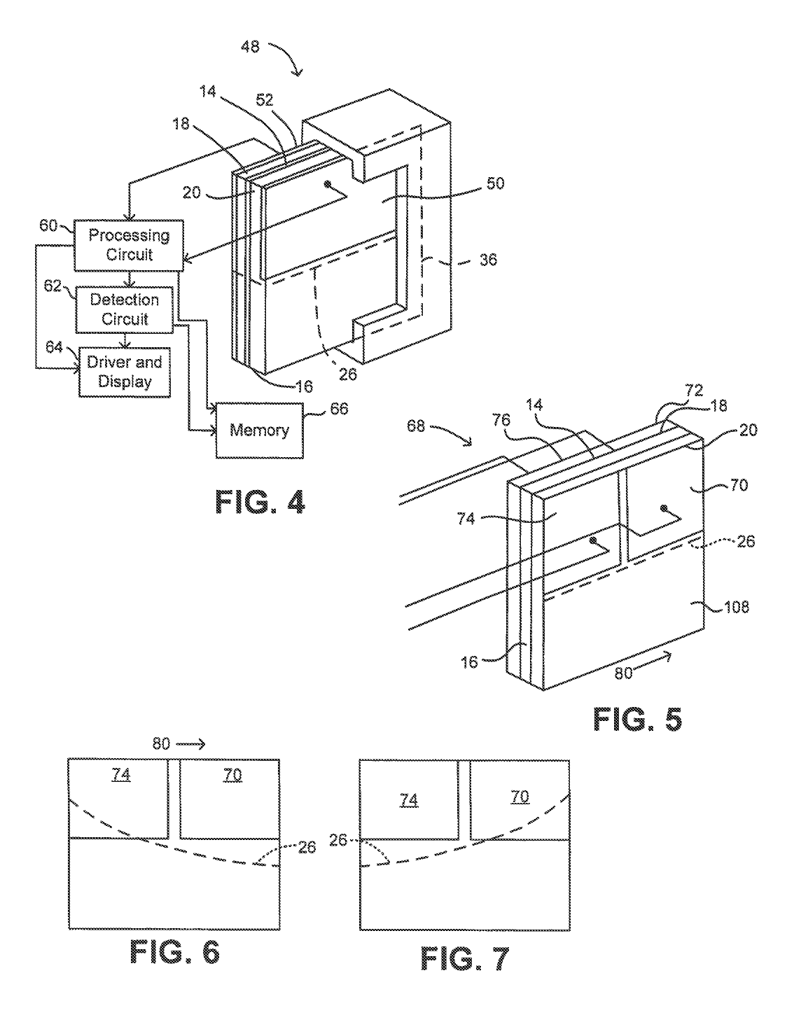

FIG. 4 illustrates an embodiment wherein capacitive sensing is used. In this embodiment first and second capacitor plates 50, 52 are disposed on either inner or outer surfaces of or within the planar members 18, 20. Preferably, the plates 50, 52 extend in the illustrated embodiment from an upper surface of the planar members 18, 20 downwardly to a point just above the interface 26, although the plates need not extend fully up to the upper surface or extend completely down to the point just above the interface 26. The plates 50, 52 may have a front-to-back dimension extending fully or partly between the front and rear walls 36, 38. In fact, although the plates 50, 52 are illustrated as having a rectangular shape, the plates 50, 52 may instead be of any regular or irregular shape, as desired or necessary. The plates 50, 52 may be electrically connected to an optional processing circuit 60 which undertakes digital signal processing or other signal processing, as required or desired, to filter out variations in the level of the interface 26 shown in FIG. 3. A detection circuit 62 may determine when the interface between the material 16, which may be a dielectric material, and the material 14, which may be a non-dielectric material, reaches a particular level between the plates 50, 52. Such an occurrence may be detected by sensing the capacitance between the plates 50, 52, or by sensing another electrical characteristic. A driver and display circuit 64 may be responsive either to the processing circuit 60 and/or the detection circuit 62 to provide either a discrete or a continuous indication of acceleration. A memory device 66, which may comprise one or more conventional memory elements, such as a tape drive or the like, may store signals representing the outputs of the processing circuit 60 and/or the detection circuit 62 to provide an indication of the history of the acceleration of the accelerometer 48.

As should be evident from the foregoing, the embodiment of FIG. 4 is only capable of determining a magnitude of acceleration or deceleration, but not the direction. The embodiment of FIG. 5 overcomes this limitation by providing first and second sets of plates 70, 72 and 74, 76. The plates 70-76 may terminate at an upper end of the planar members 18, 20 and may extend downwardly to a point just above the interface 26 when the accelerometer 68 is at rest. The plates 70, 72 are disposed forward of the mid-line 44 and the plates 74, 76 disposed rearward of the mid-line 44. Again, the set of plates 70-76 may be of shapes different than as shown, as noted in connection with the embodiment of FIG. 4. Assuming that the material 16 is a dielectric material and the material 14 is a non-dielectric material (or vice versa), a rise in the interface 26 between the plates 74, 76 in response to acceleration along a direction 80 results in a change in capacitance between the plates 74, 76 that may be detected. The change in magnitude of the capacitance may be used by appropriate signal processing and detection devices, such as those illustrated in FIG. 4, to obtain a measurement of the acceleration and the direction thereof. Conversely, deceleration (i.e., acceleration in a direction opposite to the direction of the arrow 80) of the accelerometer 68 results in a change of the interface 26 to that shown in FIG. 7, thereby leading to a change in the capacitance between the plates 70, 72, which change can be compensated and detected by the circuit shown in FIG. 4 to obtain a measurement of such deceleration.

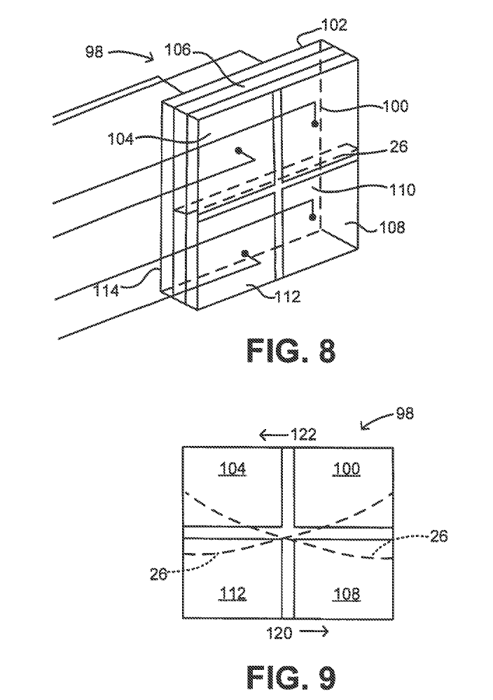

FIG. 8 eight illustrates four sets of capacitor plates 100, 102 and 104, 106 and 108, 110 and 112, 114. In this case, the changes in the capacitance between the plates of each set may be detected to determine the magnitude and direction of acceleration of the accelerometer 98. For example, as seen in FIG. 9, when the accelerometer 98 is accelerated in the direction indicated by the arrow 120, the interface 26 moves to the position illustrated by the dashed line of FIG. 9, whereas when the accelerometer 98 has accelerated in the direction of arrow 122 the interface 26 moves to the position indicated by the alternating short and long lines of FIG. 9.

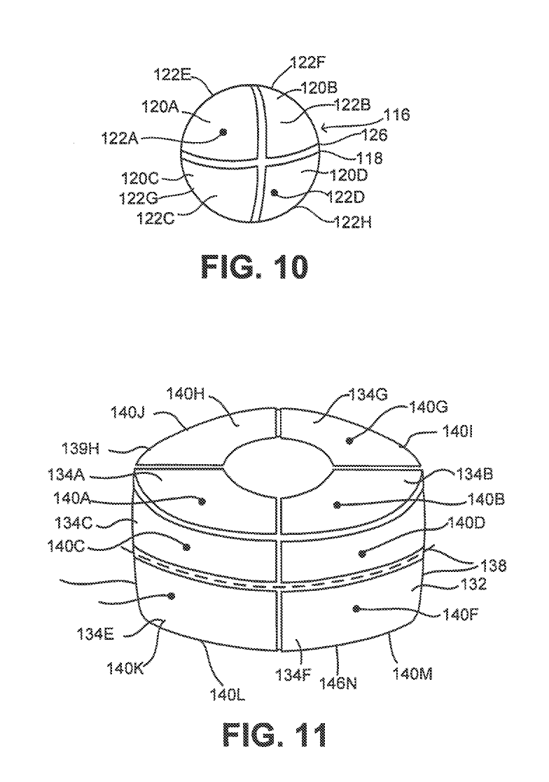

FIGS. 10 and 11 illustrate further embodiments of accelerometers. In particular, FIG. 10 illustrates an accelerometer 116 having a spherical housing 118 having a plurality of plates 120A, 120B, 120C, and 120D (all of which are visible in FIG. 10) as well as identical plates on the side of the spherical housing 118 not visible in FIG. 10 that together may form a symmetrical arrangement of plates. Electrodes 122A-122D are connected to the plates 120A-120D, respectively, and electrodes 122E-122H are connected to the identical plates on the reverse side of the spherical housing 118. As in previous embodiments, the spherical housing 118 includes at least two, and, in this embodiment, possibly more freely-flowable materials and at least one interface between freely-flowable materials is disposed at the dashed line 126 between the plates 120A, 120C and between the plates 120B, 120D when the spherical housing 118 is in the position shown in FIG. 10. The electrodes 122A-122H are connected to appropriate circuitry, such as that disclosed in FIG. 4 to compensate and detect the changing capacitances between pairs of plates, for example, the plates 120A and 120C or the plates 120A and the diametrically opposite plate on the rear face of the spherical housing 118, as well as other pairs of plates, to obtain an indication of acceleration magnitude and direction.

FIG. 11 illustrates an accelerometer 130 having a toroidal housing 132 and a plurality of plates including plates 134A-134G and other plates not visible in FIG. 11 but which are identical to the plates 134A-134G to form a symmetrical arrangement of plates. As in the previous embodiments, the housing 132 is filled with at least two and perhaps more freely-flowable materials wherein at least one interface is present at a level represented by a dashed line 138. Electrodes 140A-140N are connected to corresponding plates 134. The capacitances between pairs of plates 134 are measured as before to determine acceleration magnitude and direction.

In a resistive sensing scheme, the plates of the various embodiments may be used, whereupon an electrically conductive (or partially conductive) material is used as one of the materials 14, 16 while the other material is non-electrically conductive. Of course, in this case, the plates must be disposed in contact with the contents of the chamber 12 whether directly or through the planar members 18, 20. Also in this embodiment, a measure of resistance between plates is obtained by the circuitry of FIG. 4, in turn, to obtain a measure of acceleration magnitude and direction.

Of course, any number of plates may be used and the plates may assume any size and shape to obtain acceleration measurements. Further, each plate may be associated with any other plate to form a capacitor or resistive path whose capacitance or resistance may be measured to obtain a measure of the magnitude and direction of acceleration. The resulting changes in capacitance or resistance of the various pairs of plates can be used either differentially or additively or in any other fashion to obtain a measure of the magnitude and direction of acceleration.

Still further, other housing shapes, electrode shapes, sizes, and arrangements may be used, as desirable.

It should be noted that any of the embodiments herein may utilize a single freely flowable material disposed in any of the enclosures, in which case the remainder of the enclosure may be evacuated and the surface of the material out of contact with the wall(s) defining the enclosure may be detected as an indication of acceleration. It should also be noted that any suitable digital or analog signal processing technique(s) may be utilized by the circuit 60 in any of the embodiments herein to process the outputs of the sensor(s), including a filter function (such as a low pass filter). The signal processing techniques may be undertaken by a digital or analog signal processing circuit 60. The circuit 60 may be programmable, hard-wired, a microcontroller, an ASIC, an analog filter, etc.

One or more features of an embodiment disclosed herein may be combined with one or more features of one or more other embodiments. Modifications may be made to any embodiment as should be evident to one of ordinary skill in the art.

I/we claim:

1. An accelerometer, comprising:
an enclosure;
a flowable material disposed in the enclosure means for developing a signal representing a shape of a surface of the flowable material in the enclosure; and
means responsive to the developing means for deriving an indication of acceleration from the signal.

2. The accelerometer of claim 1, wherein the developing means comprises one of a proximity sensor, an optical sensor, a resistive sensor, and a capacitive sensor.

3. The accelerometer of claim 1, wherein the enclosure comprises a cavity defined by spaced planar members.

4. The accelerometer of claim 3, wherein the cavity comprises a substantially uniform gap between the planar members.

5. The accelerometer of claim 1, wherein the flowable material is a fluid.

6. The accelerometer of claim 1, wherein the flowable material is a liquid.

7. The accelerometer of claim 1, wherein the flowable material is a particulate solid.

8. The accelerometer of claim 1, wherein the enclosure is evacuated except for the presence of the flowable material therein.

9. The accelerometer of claim 1, wherein the flowable material comprises a first material and further including a second material in the enclosure and wherein the signal represents a shape of a surface at an interface between the first and second materials.

10. The accelerometer of claim 1, wherein the deriving means comprises a programmable device.

11. The accelerometer of claim 1, wherein the deriving means comprises a filter.

12. An accelerometer for detecting acceleration, comprising:
an enclosure;
a flowable material disposed in the enclosure;
a plurality of sensors disposed about the enclosure and adapted to develop a plurality of signals representing a distribution of the flowable material in the enclosure;
a circuit responsive to the plurality of signals for developing a further signal representing a shape of a surface of the flowable material in the enclosure and for developing an indication of acceleration from the further signal.

13. The accelerometer of claim 12, wherein each of the sensors comprises one of a proximity sensor, an optical sensor, a resistive sensor, and a capacitive sensor.

14. The accelerometer of claim 13, wherein the material is one of a fluid and a particulate solid.

15. The accelerometer of claim 14, wherein the enclosure is evacuated except for the presence of the flowable material therein.

16. The accelerometer of claim 14, wherein the flowable material comprises a first material and further including a second material in the enclosure and wherein the further signal represents a shape of a surface at an interface between the first and second materials.

17. The accelerometer of claim 14, wherein the circuit comprises a programmable device.

18. An accelerometer, comprising:
means defining a cavity;
first and second freely-flowable materials disposed in the cavity;, and
means for detecting an interface between their freely-flowable materials to obtain an indication of acceleration.

19. The accelerometer of claim 18, wherein the defining means comprises closely spaced planar members that define a substantially uniform gap therebetween.

20. The accelerometer of claim 19, wherein the materials occupy mutually exclusive volumes of the gap between the planar members.

21. The accelerometer of claim 20, wherein the interface detecting means comprises a plurality of sensors each comprising one of a proximity sensor, an optical sensor, a resistive sensor, and capacitive sensor and further including means for developing an output signal from signals developed by the plurality of sensors.

22. The accelerometer of claim 21, wherein the output signal is representative of acceleration.

23. The accelerometer of claim 21, further including signal processing means to obtain an indication of acceleration magnitude and direction from the output signal.
